(19) United States
(12) Patent Application Publication
(10) Pub. No.: US 2018/0095330 A1
(43) Pub. Date: Apr. 5, 2018

(54) TEXTURE GRADIENT FOR UNIFORM LIGHT OUTPUT FROM A TRANSPARENT BACKLIGHT

(71) Applicant: CORNING INCORPORATED, CORNING, NY (US)

(72) Inventors: Michael Etienne, Corning, NY (US); Ioannis Georgios Roudas, Bozeman, MT (US); Adama Tandia, Nelson, PA (US); Aramais Robert Zakharian, Painted Post, NY (US)

(21) Appl. No.: 15/564,986

(22) PCT Filed: Apr. 5, 2016
(86) PCT No.: PCT/US16/25980

§ 371 Date: Oct. 6, 2017

Related U.S. Application Data
(60) Provisional application No. 62/143,996, filed on Apr. 7, 2015.

(51) Int. Cl. G02F 1/1335

(52) U.S. Cl. CPC G02F 1/133606; G02F 1/133603; G02F 1/133611; G02F 1/133608

(57) ABSTRACT

A light diffusing component and a method of making is disclosed. The light diffusing component may include a substrate sheet and at least one scattering layer. The substrate sheet may have a back side and an edge. The edge may be configured to receive a light source. The at least one scattering layer may have a plurality of light scattering centers etched into at least a portion of the back side of the glass sheet. The scattering centers may have an increased density as the distance from the edge increases. The scattering centers may have a diameter of less than about 30 microns, a maximum depth of about 10 micron or less, and a roughness between about 0.5 nm to about 100 nm, for example.

### CROSS-REFERENCE TO RELATED APPLICATIONS

This application claims the benefit of priority under 35 U.S.C. § 119 of U.S. Provisional Application Ser. No. 62/143,996 filed on Apr. 7, 2015, the content of which is relied upon and incorporated herein by reference in its entirety.

### BACKGROUND

The present disclosure relates generally to a light diffusing component, and, more particularly, to a light guide for use in a transparent or translucent display.

A typical transmissive display may include a liquid crystal stack illuminated by a uniform backlight. The backlight, in a transmissive display, is a collection made of the light guide with embedded scattering centers, light management films such as an IDF (image directing film) and a D-BEF (brightness enhancing film), followed by a diffuser. The combined performances of these light management films help deliver a backlight assembly with uniform brightness all across its dimensions. Because the backlight is hidden behind a number of components, including cross polarizers, the architecture of transmissive backlights is more forgiving.

The main structure of any LCD (liquid crystal display) system is the light guide that illuminates many LCD cells. The most common and current implementation uses side-located LED light sources injecting light into the light guide. The light guide is itself embedded with scattering centers at the bottom surface. These scattering centers either concave or convex are responsible for scattering and redirecting the light propagating through the light guide. If the scattering centers or dots are placed periodically along the light guide, the light extraction pattern follows an exponential decay, where most of the power is extracted at the beginning and gradually falls off as less and less power remains available in the light guide. To maintain uniform brightness across the whole light guide, the scattering center distribution must be such that less extraction scattering centers are available where the power is high (near the LEDs) and more extraction scattering centers are made available where the power is low. In such an implementation, the size of the scattering centers often remains constant and well-defined (typically hundreds of microns to a millimeter in size), while the distance between scattering centers decreases from around 300-μm near the LEDs to around 30-μm at the opposite end of a one-dimensional gradient.

A recent trend in displays is toward transparent and translucent displays. Potential uses for transparent or translucent displays include hospital walls, building windows, digital signage, window advertisement, and heads-up displays. Transparent displays may stimulate the concept of display on demand, where the display will only be there when you want it.

Different from a transmissive display, in a transparent or translucent display, the only components that may be present are the translucent LCD stack and the light guide. In a transparent or translucent display, there are no more diffusers, light management films, or back reflector.

### BRIEF SUMMARY

The present disclosure relates, in various embodiments, to a light diffusing component. The light diffusing component may include a substrate sheet and at least one scattering layer. The substrate sheet may have a front side, a back side, and an edge. The edge may be configured to receive a light source. The at least one scattering layer may have a plurality of light scattering centers etched into at least a portion of the back side of the glass sheet. The scattering centers may have an increased density as the distance from the edge increases. The scattering centers may have a diameter of less than about 30 microns, a maximum depth of about 10 micron or less, and a roughness between about 0.5 nm to about 100 nm, for example.

The present disclosure also relates, in various embodiments, to another light diffusing component. The light diffusing component may have a substrate sheet and at least one scattering layer. The substrate sheet may have a front side, a back side, and an edge. The edge may be configured to receive a light source. The at least one scattering layer may have a plurality of light scattering centers etched into at least a portion of the back side of the glass sheet. The scattering centers may increase in size as the distance from the edge increases. The scattering centers may have a diameter from about 50 nm to about 50 microns, a maximum depth of about 10 micron or less, and a roughness between about 0.5 nm to about 100 nm, for example.

The present disclosure additional relates to yet another light diffusing component. The light diffusing component may comprise a substrate and at least one scattering layer. The substrate may have a front side, a back side, and an edge. The edge may be configured to receive a light source. The at least one scattering layer may have a plurality of light scattering centers. The scattering centers may increase in size as the distance from the edge increases. The scattering centers may having a diameter from about 50 nm to about 50 microns, a maximum depth of about 10 microns or less, and a roughness between about 0.5 nm to about 100 nm, for example.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF SEVERAL VIEWS OF THE DRAWINGS

FIG. 1 is a side-sectional view of a light diffusing component in accordance to one embodiment.

FIG. 2 is a front elevational view of the light diffusing component of FIG. 1.

FIG. 3 is an enlarged view of a-a¹ of the scattering layer on the light diffusing component of FIG. 1.

FIG. 4a is a front view of the scattering layer on the light diffusing component of FIG. 1 according to one embodiment.

FIG. 4b is a cross-sectional view of the scattering layer on the light diffusing component along the line C-C¹ according to one embodiment.

FIG. 4c is an enlarged view of b-b¹ of the scattering center as shown in FIG. 4b according to one embodiment.

FIG. 5 is a front view of the scattering layer on the light diffusing component of FIG. 1 according to another embodiment.

FIG. 6 is a front view of the scattering layer on the light diffusing component of FIG. 1 according to yet another embodiment.

FIG. 7a is a graph illustrating the scattering attenuation coefficient α(z) constructed to leave only 5% of the input light at the mid-point (z=0) of the substrate.

FIG. 7b is a graph illustrating a nearly uniform output Q(z) with a maximum at the mid-point in a system with two-sided symmetric illumination.

FIG. 8a is a graph illustrating the scattering attenuation coefficient α(z) within a range of 0.01 mm⁻¹ to about 0.04 mm⁻¹.

FIG. 8b is a graph illustrating a quasi-uniform output Q(z) with a maximum at the mid-point for a six inch long device.

The following reference characters are used in this description and the accompanying drawing figures.

| | |
|---|---|
| 100 | A light diffusing component |
| 110 | Substrate sheet |
| 120 | Light source |
| 130 | Light |
| 140 | Scattering layer |
| 150 | One or more edges or borders |
| 160 | Back side |
| 170 | front side |
| 210 | Light scattering center |
| 410 | Diameter of the light scattering center 210 |
| 420 | Maximum depth of the light scattering center 210 |
| 430 | Roughness of light scattering center 210 |

### DETAILED DESCRIPTION

Reference will now be made in detail to embodiments of the present technology, examples of which are illustrated in the accompanying drawings. Whenever possible, the same reference numerals will be used throughout the drawings to refer to the same or like parts.

The present disclosure provides a light diffusing component for use in a transparent or translucent display. Developing transparent backlights for translucent displays may be very challenging. Liquid crystal display (LCD) monitors are equipped with a backlight module in order to produce a visible image. The backlight module may be composed of arrays of light-emitting diodes (LEDs) and a rectangular glass light guide plate. The purpose of the light guide is to direct the LED light, injected at one or two opposite edge facets, towards the LCD panel. A typical transmissive display backlight may be made of not just the light-guide and light sources, but numerous light management films compensating for stray light redistribution, brightness, color uniformity, and viewing angle. The challenge may be to provide a backlight that yields similar performance but in a single transparent glass sheet. Among the above mentioned characteristics of a backlight, light extraction uniformity or the distribution of the light over the entire surface of the light-guide seems to be a most pressing problem to solve. For example, current transparent displays need a transflective stack that may be illuminated in reflection by recirculating ambient light or in transmission by allowing light to be injected from the back of the display. Brightness measurements performed on such transflective displays show autonomous panel illumination around 5-10 nits, while brightness measurements of a good display may reach at least 200 nits. For translucent LCD displays to be competitive, a backlight that is transparent in the OFF-state but fully bright in the ON-state may need to be developed.

The present disclosure discloses a gradient texture design with domain sizes in the nano-micro regime for uniform light output to be used in a transparent backlight unit. By properly choosing the dot-to-dot spacing, as well as the dot height and roughness, the resulting dot array layout may provide maximum transparency, minimum haze, and uniform light output. The scattering function may be chosen such that the light output profile may be tailored to be application specific.

The present disclosure may provide many advantages. For example, the light extraction features may provide an improvement in brightness resulting in a much improved contrast ratio. The features may be made very small, with sizes less than about 20 microns, invisible to the naked eyes. The coverage ratio may be chosen such that full transparency of the light-guide may be achieved everywhere. The geometry of the dots may be engineered to improve light management. The scattering function of the guide may be chosen such that different light extraction profiles may be achieved. The features may be implemented directly in glass, eliminating the need for a back cover glass. Ion-exchange glass may offer better scratch resistance and durability than polymer. The pattern may be made random to avoid Moire interference between the liquid crystal display and features on the backlight.

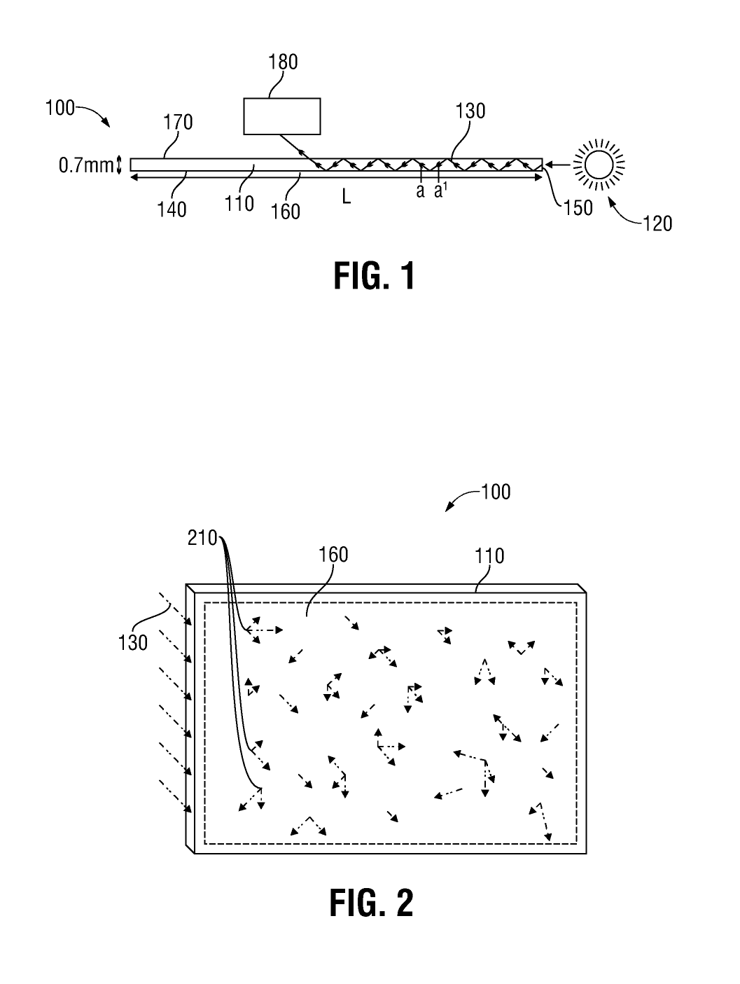

With reference to FIG. 1, a light diffusing component 100 in accordance with one or more embodiments herein may be employed to process light for a display system or other applications. In general, the diffusing component 100 may include a substrate sheet 110 and at least one scattering layer 140. The substrate sheet 110 may operate to receive a light source 120 from one or more edges or borders 150 of the structure, propagate the light 130 within the substrate sheet, diffuse and scatter the light 130 out a front of the structure (as illustrated by the arrows in FIG. 2) for useful purposes. The light 130 out of the structure may be detected by a detector 180. The general structure of the substrate sheet 110 used in the light guide may be as a sheet having two major planar surfaces roughly parallel to each other, described herein as the back side 160 and front side 170, and at least one edge 150 roughly orthogonal to and connecting the two major planar surfaces. In some embodiments, the substrate may be rectangular in shape with four edges. The edge may be flat (or planar), or may have bevels or other configurations that connect it to the back side 160 and front side 170.

As shown in FIG. 2, the at least one scattering layer 140 may have a plurality of light scattering centers 210 etched into at least a portion of the back side of the substrate sheet. The light scattering centers 210 may be sub-micron sized (e.g., nanometer sized), randomly located, disposed on and/or in the back side 140 of the substrate sheet 110.

As illustrated by the dashed arrows, light 130 may enter the substrate sheet 110 and begin propagating there through until the rays of light impinge upon the scattering centers 210. Given the optical properties of the substrate sheet 110 and the scattering centers 210, the light scatters out of the light diffusing component 100. The optical characteristics are generally of the surface scattering variety or volumetric scattering variety (depending on the depth of the scattering layer 140) and may be controllable via the process for producing the scattering centers 210.

It has been found that the sizes of the plurality of light scattering centers 210 may affect the light scattering properties of the light diffusing component 100. In particular, relatively small sized centers 210 scatter backward as well as forward, and particles of about 150 nm and larger scatter predominately forward, which may be generally desirable in the light diffusing component 100. Indeed, scattering in predominantly the forward direction facilitates high transmission ratios and suitable haze ratios in the light diffusing component 100. More particularly, the general dimensions of the light scattering centers 210 may be on the order of about 200 nm in order to achieve a high transmission ratio. Indeed, as smaller feature sizes of the light scattering centers 210 tend to backscatter the light, the resultant transmission ratio would be adversely affected. Light scattering centers 210 of a size greater than about 500 nm scatter light forward, but the angular spread is small, which is less desirable. Given the above optical scattering characteristics as a function of light scattering center size, the approximate feature size of the scattering centers 210 may be one of: (i) between about 100 nm to about 500 nm, (ii) between about 200 nm to about 300 nm, and (iii) about 250 nm.

The optical light scattering characteristics of the diffusing apparatus 100 are also affected by the respective refractive indices of the substrate sheet 110 and the light scattering centers 210. The substrate sheet 110 (and the optional over-coating material) may likely have refractive indices on the order of about 1.4-1.6.

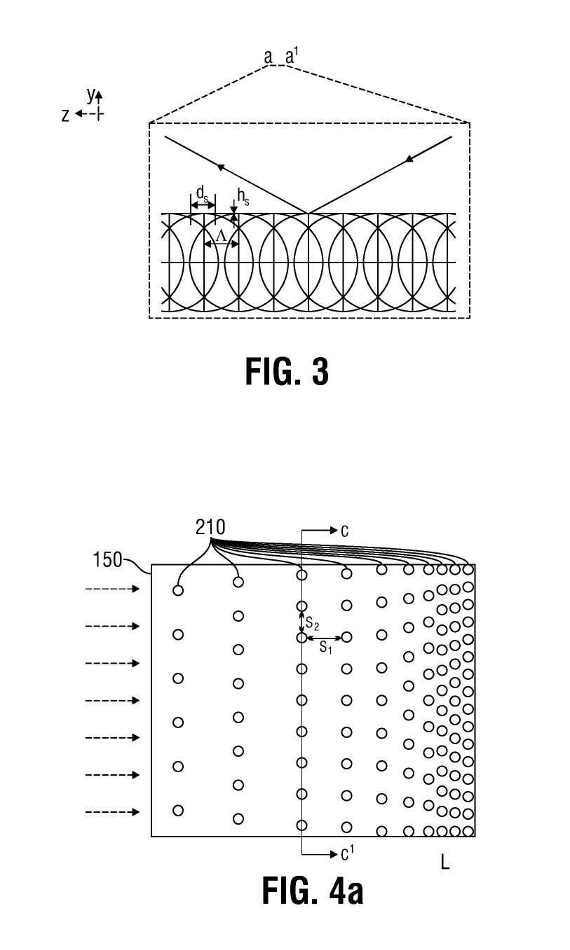

A schematic drawing of a substrate textured by scattering centers arranged on a lattice with period Λ(z) is shown in FIG. 3. For illustration and modeling purposes, the texture may be represented by an array of scattering centers arranged on a lattice of period Λ(z) that changes along the substrate length. In general, the scattering centers may be distributed in a quasi-regular fashion along the x and z axis, maintaining the average scattering density prescribed by Λ(z). In the model, scattering elements may simulate an etched region of depth hₛ, width ds and a shape defined by a sphere of radius (hₛ²+dₛ²/4)/(2hₛ), or alternatively, white-paint dots with broad-angle scattering distribution.

The details of the scatterer shape may affect the extraction efficiency and angular distribution of the out-coupled light, while the Λ(z) function may be designed for uniform distribution of light along the z-axis. The model is three-dimensional, with mirror boundary conditions used to simulate an extended system with one- or two-sided illumination.

To maintain uniform brightness across the entire light guide, the scattering center distribution may be such that less scattering centers are located where the power is high (near the light source) and more scattering centers are made available where the power is low. Light intensity in the light guide typically falls off in a nonlinear fashion.

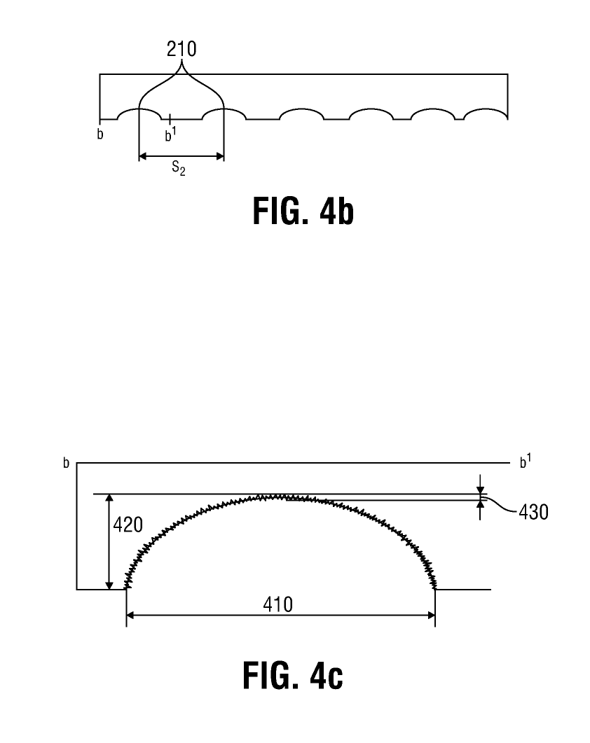

As shown in FIG. 4a, the scattering centers 210 may have an increased density as the distance from the edge 150 increases. As shown in enlarged drawings FIGS. 4b and 4c, the scattering centers 210 may have a diameter 410 of less than about 30 microns, for example, in one embodiment. In another embodiment, the diameter 410 of the scattering centers may be less than 20 microns, for example. The scattering centers may have a maximum depth 420 of about 10 microns or less, for example, in one embodiment. In another embodiment, the maximum depth 420 of the scattering centers 210 may be about 1 micron or less. The scattering center 210 may have a roughness 430, between about 0.5 nm to about 100 nm, for example, in one embodiment. In another embodiment, the roughness 430 may be less than about 50 nm, for example. The roughness may be measured as Ra or Rq(rms), for example. Ra may be defined as arithmetical mean deviation. The average roughness or deviation of all points from a plane fit to the test part surface. Rq(rms) may be defined as root-mean-square (rms) roughness. The average of the measured height deviations taken within the evaluation length or area and measured from the mean linear surface. In one embodiment, the center to center distance, such as s₁ or s₂, between adjacent scattering centers is no greater than about 40 microns, for example. In another embodiment, the center to center distance, such as s₁ or s₂, between adjacent scattering centers is no less than about 50 nanometers, for example.

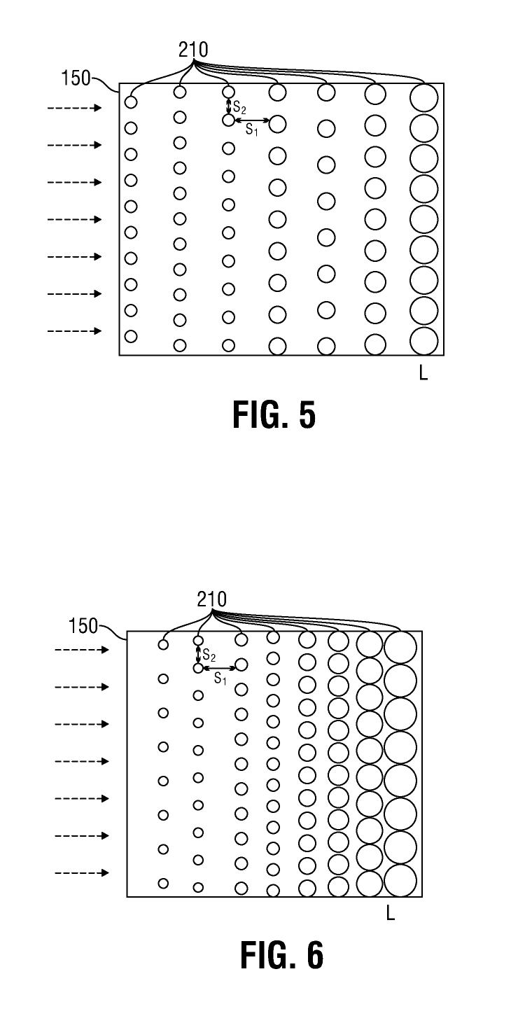

In another embodiment, as shown in FIG. 5, the scattering centers 210 may increase in size as the distance from the edge 150 increases. The scattering centers 210 may have a diameter from about 50 nm to about 50 microns, for example. In further embodiment, the scattering center 210 may have a diameter less than about 20 microns, for example. The scattering center 210 may have a maximum depth of about 10 microns or less, for example, in one embodiment. In another embodiment, the maximum depth of the scattering centers may be about 1 micron or less, for example. The scattering center 210 may have a roughness between about 0.5 nm to about 100 nm, for example, in one embodiment. In another embodiment, the roughness may be less than about 50 nm, for example. In one embodiment, the center to center distance, such as s₁ or s₂, between adjacent scattering centers is no greater than about 40 microns, for example. In another embodiment, the center to center distance, such as s₁ or s₂, between adjacent scattering centers is no less than about 50 nanometers, for example.

In further another embodiment, as shown in FIG. 6, the scattering centers 210 may have an increased density as the distance from the edge 150 increases. The scattering centers 210 may increase in size as the distance from the edge 150 increases. The scattering centers may have a diameter from about 50 nm to about 50 microns, for example. In further embodiment, the scattering center 210 may have a diameter less than about 20 microns, for example. The scattering center 210 may have a maximum depth of about 10 micron or less, for example, in one embodiment. In another embodiment, the maximum depth of the scattering centers may be about 1 micron or less, for example. The scattering center 210 may have a roughness between about 0.5 nm to about 100 nm, for example, in one embodiment. In another embodiment, the roughness may be less than about 50 nm, for example. In one embodiment, the center to center distance, such as s₁ or s₂, between adjacent scattering centers is no less than about 50 nanometers, for example. In another embodiment, the center to center distance, such as s₁ or s₂, between adjacent scattering centers is no greater than about 40 microns, for example.

For uniform output distribution, the dependence of the scattering function on the coordinate is given by formula (1):

$$α ( z ) = {[ ( \frac{{I}_{0}}{Q} + \frac{1}{{α}_{a}} ) {e}^{- {α}_{a} z} - \frac{1}{{α}_{a}} ]}^{- 1}$$

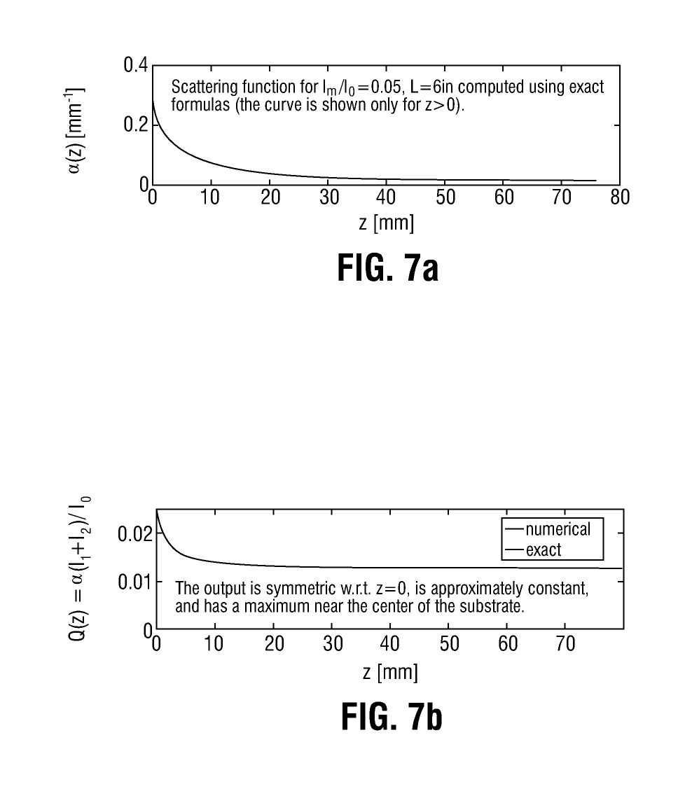

The quantities I₀, Q, and αₐ respectively define the input intensity, constant irradiance and absorption coefficient due to intrinsic losses in the substrate. FIG. 7a shows an example of the scattering attenuation coefficient α(z) constructed to scatter 95% of the input light (Iₘ/I₀=0.05, where Iₘ denotes the intensity at midpoint) over the half-length (L/2) of a lossless substrate. In a system with two-sided symmetric illumination, this may lead to a nearly uniform output with a maximum at the mid-point, as shown in FIG. 7b. FIGS. 7a and 7b have shown an example of the scattering attenuation coefficient α(z) constructed to leave only 5% of the input light at the mid-point (z=0) of the slab, resulting in a nearly uniform output Q(z) with a maximum at the mid-point in a system with two-sided symmetric illumination. Solution for only the right-half (z>0) is shown. I₁, I₂ and I₀ that appear in the definition of Q(z) denote the intensity of light propagation in the positive z-direction, the negative incident direction, and at the input of the light-guide, respectively.

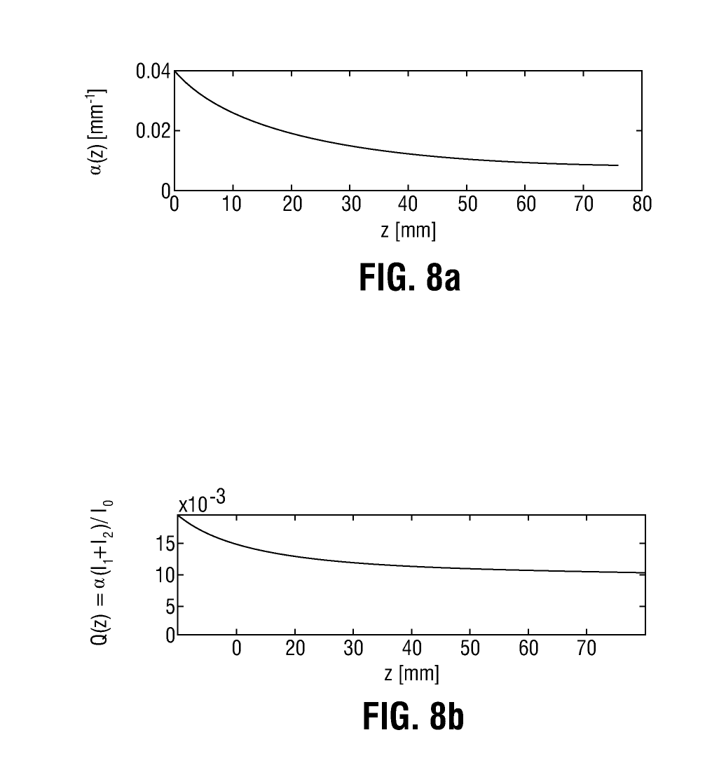

In general, for a given length L of the substrate, the parameter Iₘ/I₀ may be used to estimate the desired shape of the output irradiance and of the scattering function. For L=6 inches (about 15 cm), using Iₘ/I₀=0.25, one may find the scattering attenuation coefficient shown in FIG. 8a within a range of about 0.01 mm⁻¹ to about 0.04 mm⁻¹ which may lead to a quasi-uniform intensity for a 6 inch long substrate with a maximum in the center shown in FIG. 8b. If absorption losses are smaller than 0.001 mm⁻¹, the estimate may be expected to provide a good initial approximation for the scattering function (for 2318 low-iron Gorilla glass, the attenuation may be about 1.3-1.5×10⁻³ mm⁻¹ at wavelengths 528 nm-622 nm).

The output intensity for scattering elements of a desired size and a range of densities may be computed to relate the scattering coefficient α(z) to the scatterer density Λ(z). The experimental results for white-paint dots applied with a uniform coverage and discrete etched dots may show that the measured scattering coefficient values may be in the range of about α=0.004 mm⁻¹ to 0.022 mm⁻¹ for samples with 50 microns diameter and 300 micron spacing. This range of α(Λ) may overlap with the range required to achieve a quasi-uniform output for a 6 inch long substrate.

The scattering centers may be made of nano to micro size white scattering paint or ink dots. The white scattering paint or ink dots may be less than 40 microns. The dots may be printed directly on the bottom of the glass surface, with dot density gradually away from the light source. The dot spacing distribution may be chosen such that the attenuation coefficient allows for uniform illumination across the full surface of the light guide. The dots may be made random as to not generate a Moire interference pattern with the LCD stack. Additionally, the dot per pixel ratio may be chosen such that the ratio is at least one. In another embodiment, the scattering centers may be implemented by using discrete etched dots. The etched dots may be obtained by using a wet chemical etch process.

By properly choosing the dot-to-dot spacing as well as the dot height and roughness, the resulting dot array layout may provide maximum transparency, minimum haze, and uniform light output. The scattering function may be chosen such that light output profile may be tailored to be application specific.

It will be apparent to those skilled in the art that various modifications and variations can be made without departing from the spirit and scope of the aspects described herein, which is defined by the appended claims.

1. A light diffusing component comprising:
a substrate sheet having a front side, a back side, and an edge configured to receive a light source; and
at least one scattering layer having a plurality of light scattering centers etched into at least a portion of the back side of the substrate sheet, the scattering centers having an increased density as the distance from the edge increases, the scattering centers having a diameter of less than about 30 microns, a maximum depth of about 10 microns or less, and a roughness between about 0.5 nm and about 100 nm.

2. The light diffusing component of claim 1, wherein the diameter of the scattering centers is less than about 20 microns.

3. The light diffusing component of claim 1, wherein the maximum depth of the scattering centers is about 1 micron or less.

4. The light diffusing component of claim 1, wherein the roughness is less than about 50 nm.

5. The light diffusing component of claim 1, wherein the substrate sheet is at least one of a glass sheet, plastic, or transparent ceramics.

6. The light diffusing component of claim 1, wherein the center to center distance between adjacent scattering centers is no less than about 50 nanometers.

7. The light diffusing component of claim 1, wherein the center to center distance between adjacent scattering centers is no greater than about 40 micrometers.

8. A light diffusing component comprising:
a substrate sheet having a front side, a back side, and an edge configured to receive a light source; and
at least one scattering layer having a plurality of light scattering centers etched into at least a portion of the back side of the glass sheet, the scattering centers increasing in size as the distance from the edge increases, the scattering centers having a diameter from about 50 nm to about 50 microns, a maximum depth of about 10 micron or less, and a roughness between about 0.5 nm to about 100 nm.

9. The light diffusing component of claim 8, wherein the diameter of the scattering centers is less than about 20 microns.

10. The light diffusing component of claim 8, wherein the maximum depth of the scattering centers is about 1 micron or less.

11. The light diffusing component of claim 8, wherein the roughness is between less than about 50 nm.

12. The light diffusing component of claim 8, wherein the substrate sheet is at least one of a glass sheet, plastic, or transparent ceramics.

13. The light diffusing component of claim 8, wherein the center to center distance between adjacent scattering centers is no less than about 50 nanometers.

14. The light diffusing component of claim 8, wherein the center to center distance between adjacent scattering centers is no greater than about 40 microns.

15. A light diffusing component comprising:
a substrate sheet having a front side, a back side, and an edge configured to receive a light source; and
at least one scattering layer having a plurality of light scattering centers etched into at least a portion of the back side of the glass sheet, the scattering centers having an increased density as the distance from the edge increases and the scattering centers increase in size as the distance from the edge increases, the scattering centers having a diameter from about 50 nm to about 50 microns, a maximum depth of about 10 micron or less, and a roughness between about 0.5 nm to about 100 nm.

16. The light diffusing component of claim 15, wherein the diameter of the scattering centers is less than about 20 microns.

17. The light diffusing component of claim 15, wherein the maximum depth of the scattering centers is about 1 micron or less.

18. The light diffusing component of claim 15, wherein the roughness is between less than about 50 nm.

19. The light diffusing component of claim 15, wherein the center to center distance between adjacent scattering centers is no less than about 50 nanometers.

20. The light diffusing component of claim 15, wherein the center to center distance between adjacent scattering centers is no greater than about 40 microns.
